(19) United States
(12) Patent Application Publication
(10) Pub. No.: US 2008/0150373 A1
(43) Pub. Date: Jun. 26, 2008

(54) ELECTRIC CONTROL

(75) Inventor: Michael Gottschlich, Kippenheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: BERGER LAHR GMBH & CO. KG, Lahr (DE)

(21) Appl. No.: 11/957,894

(22) Filed: Dec. 17, 2007

(30) Foreign Application Priority Data
Dec. 23, 2006 (DE) 102006061476.3

(51) Int. Cl. H02H 1/06

(52) U.S. Cl. 307/326

(57) ABSTRACT

An electric control (1) for electric devices (2), in particular electromotive drives, which can trigger dangerous motions, is provided with an emergency-off switch (4), having at least two channels for a power supply, allowing one or more electric devices (2) to be connected at the outlet side. One safety unit (3) is provided with at least one connector (5) for a power supply as well as at least two outlets (6, 7) for connecting one channel (A, B) each of the emergency-off switch (4). The safety unit (3) has at least two switches (8, 9) connected to the outlets (6, 7), via which the power supply is conducted and switched on and off alternately. Furthermore, a measuring device (10) is provided for controlling at least the supply power pulses at the outlets (6, 7) of the safety unit (3) and/or at the outlets of the emergency-off switch (4) and/or at one or more electric devices (2) connected to the emergency-off switch (4).

### BACKGROUND

The invention relates to an electric control for electric devices, in particular electromotive drives, which may trigger dangerous motions, with the control being provided with an emergency-off switch having at least two channels, allowing one or more electric devices to be connected at the output side.

Electric controls for machinery drive elements usually must comply with increased safety requirements. This includes, among other things, a protected or separate wiring of safety related electric cables. Additionally, emergency-off switches are used in order to ensure the stop order can be flawlessly processed when the stop order is given.

Emergency-off switches are used in different embodiment variations. Simple embodiments of emergency-off switches provide a basic safety feature and comprise a relay with positively activated contacts. This way, for example welded contacts cannot be switched on again.

Furthermore, emergency-off switches are known which allow monitoring of the connected circuits for cross circuits and shorts. These switching devices are relatively expensive, though, because usually a multitude of additional functions are implemented.

### SUMMARY

The object of the present invention is to provide an electric control of the type mentioned at the outset, which allows the use of simple, cost-effective emergency-off switches that can easily be retrofitted, and in spite thereof meets increased safety requirements.

In order to attain this object, the invention provides that the safety unit comprises at least one connector for a power supply and at least two outlets for connecting at least one channel each of the emergency-off switch, and the safety unit is provided with switches connected to its at least two outlets, by which the supplied power is conducted each and alternating being switched on and off, and that one measuring device is provided at least for monitoring the power supply pulse to the outlets of the safety unit and/or at the outlets of the emergency-off switch and/or at one or more electric devices connected to the emergency-off switch.

This safety unit forms, together with the measuring device, a simple accessory, which in connection with another simple and cost-effective emergency-off switch supports an increased safety category. Retrofitting existing emergency-off switches with a safety unit according to the invention to increase security is also possible without high expenses.

A particular advantage of the device according to the invention comprises that any separate or protected wiring is no longer necessary. Therefore the connections between the safety unit and the emergency-off switch as well as the electric device for the power supply connected thereto can be combined in a common, unprotected wiring.

The measuring device allocated to the safety unit allows an automatic testing of the connected wiring by checking if the switch-off pulses generated by the safety unit are connected to the test sites. In this way, in particular cross circuits and short circuits can be detected.

In case of malfunctions, the switches of the safety unit remain open so that the controls of the connected electric devices are not addressed. When the measuring device is provided at one or more electric devices connected to the emergency-off switch, here an error status is triggered.

In order to switch off, a respective control signal may also be sent from the measuring device to the emergency-off switch.

Using the two switches an alternating and temporarily offset switching-off process is performed via the power supply conducted through the switches.

Here the intervals of the two switches of the safety unit overlap so that during normal operation an uninterrupted power supply is provided for the connected electric devices.

The alternating disconnection of the power supply by the switches of the safety unit is particularly shorter than any reaction time of downstream connected arrangements, in particular the emergency-off switch, with the disconnection pulse preferably lasting approximately 1 ms.

This pulse duration is sufficiently long, on the one hand, to allow secure testing of the connected wiring, however it does not result in triggering the emergency-off switch, in particular.

The disconnection pulses can be repeated, depending on the requested safety requirements in shorter or longer temporal intervals, for example in one-second intervals.

The switches of the safety unit are preferably semiconductor switches in order to allow the above-mentioned short relay times and to achieve a long operational life.

The measurement device can be integrated into the safety unit and/or at least one electric device connected.

When integrating the measurement device into the safety unit testing the outlet pulses of the safety unit itself is possible and in closed switches of the emergency-off switch an additional control of the wiring is possible up to the connected electric devices.

The latter also applies for an arrangement of the measurement device(s) at or integrated into one or more of the electric devices connected. Additionally, then another control function of the wiring for faulty connections is possible between the emergency-off switch and the connected electric device, for example by the faulty connection of another power supply.

Furthermore there is the possibility to provide measurement devices both at the safety unit as well as the connected electric devices in order to provide comprehensive testing in open and closed switches of the emergency-off switch.

### BRIEF DESCRIPTION OF THE DRAWINGS

In the following, using the drawings the invention is described in its essential details.

Shown in a somewhat schematic fashion are:

FIG. 1 is a block diagram with a safety unit, a two-polar emergency-off switch, and connected devices, and

FIG. 2 is a diagram of the voltage characteristics of a power supply split into two channels downstream in reference of the safety unit.

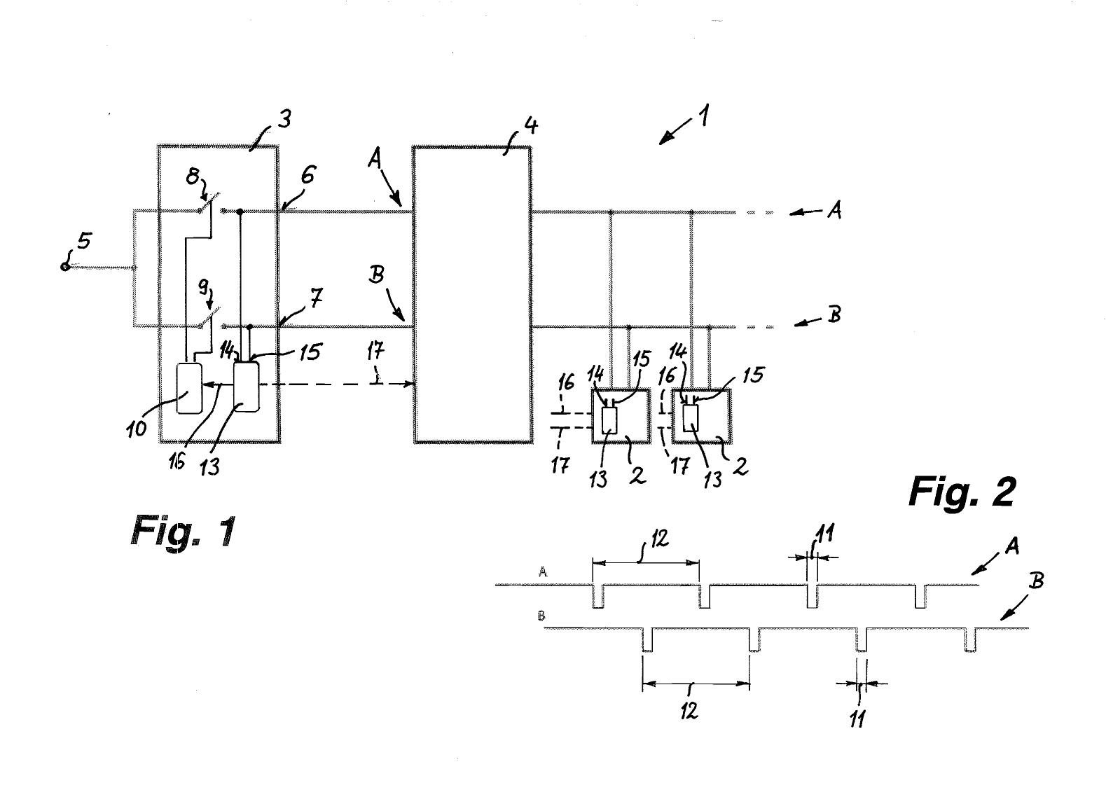

### DETAILED DESCRIPTION OF THE PREFERRED EMBODIMENTS

A part of an electric control 1 for electric devices 2 is provided with a safety unit 3, which is connected to an emergency-off switch 4.

In the exemplary embodiment, the emergency-off switch 4 is provided with two channels having a first channel A and a second channel B. The safety unit 3 is provided with a connector 5 for the power supply and two outlets 6, 7 for connecting one channel each of the emergency-off switch. The safety unit 3 comprises two switches 8, 9, via which the power supply is conducted provided at the connector 5. The switches 8, 9 are therefore connected, on the one hand, jointly to the connector 5 for a power supply and, on the other, hand individually to the outlet 6 and/or the outlet 7 of the safety unit 3.

The switches 8, 9 are preferably electric switches, which are connected to a control 10. Via said control 10, the switches 8, 9 can be switched on or off in an alternating fashion. The switch 8 is allocated with its outlet 6 to the channel A and the switch 9 with its outlet 7 to the channel B.

The temporal progression of the switching function of the two switches 8 and 9 of the safety unit 3 is well discernible in FIG. 2. Here, it is discernible that via the two switches 8, 9 an alternating and temporarily disconnection of the power supply, transmitted via the switches, is provided. The power supply connected to the outlet 6 and the outlet 7 and periodically briefly interrupted is conducted via the emergency-off switch 4 and the contacts located therein to the electric devices 2. By the temporarily off-set disconnection of the power supply to both channels A and B being brief the electric devices 2 are connected to the power supply without interruptions.

The alternating disconnection of the power supply by the switches 8, 9 of the safety unit 3 is designed such that any triggering of the emergency-off switch 4 is avoided based on the disconnection pulses. Preferably the disconnection pulse range 11 amounts to approximately one millisecond, with this value may be varied depending on the parameters of the emergency-off switch 4. The periodic disconnection pulses can be repeated, for example in one-second intervals, depending on requirements. In FIG. 2 this pulse interval is illustrated with the reference number 12.

The safety device 3 includes at least one additional measuring device 13. In the exemplary embodiment shown one measuring device 13 is integrated in both the safety unit 3 and the connected electric devices 2. The measuring devices 13 are each provided with connectors 14 and 15, respectively, which are connected to the wires allocated to the channels A and B and conducting the power supply.

The measuring device 13 located in the safety unit 3 is connected via a connector 14 to the switch 8 and via the connector 15 to the switch 9, each at the output side. This way the power supply pulses connected here (FIG. 2) can be monitored. In case of closed contacts of the emergency-off switch 4, the other conduits allocated to the channels A and B can also be controlled up to the electric devices 2. Here, the wiring connected can be tested for example for cross circuits and/or short circuits.

In the exemplary embodiment, as already mentioned, two measuring devices 13 are provided in the connected electric devices, which are connected with their connectors 14, 15 to the two-channel power supply. This way a further monitoring for defective wiring can occur, even in case of a faulty connection to the power supply. Additionally here it is detected if the emergency-off switch 4 is switched on or off.

Depending on the application it may be sufficient to provide a measuring device 13 only in one or more of the connected electric devices 2 or in the safety unit 3. The measuring devices can be integrated in the respective devices 2 or the safety unit 3 or allocated thereto.

When a disturbance or an error is detected by the measuring device 13, the two power supply channels A, B can be interrupted via a connection 16 to the control 10 in the safety unit 3 and/or via a connection 17 to the emergency-off switch 4. Therefore, in case of malfunction, an open state of the two switches 8 and 9 or a triggering and/or disconnection of the emergency-off switch 4 can occur via the control 10 so that the two power supply channels A, B are interrupted.

It remains to be mentioned that embodiment of the safety unit 3 with more than two-channels is also possible, i.e. splitting the power supply connected at the connector 5 into, for example, three channels in connection with an appropriately multi-channel emergency-off switch 4.

Overall, an automatic monitoring of the wiring at the outlets of a commercial emergency-off switch 4 via the upstream connected safety unit 3 is provided. In this manner, a peripheral automatic control of the wiring is possible by a device 2 connected to an emergency-off switch. The automatic monitoring of the wiring also has the essential advantage that the necessity of a protected or separate wiring of the cables is omitted. This means in the practical application, for example in connection with compact drives, considerably simpler wiring and less costs for plug connectors. The preferred application is for electromotive drives, which can trigger dangerous motions.

1. An electric control (1) for electric devices (2) which can trigger dangerous motions, the control comprising an emergency-off switch (4) having at least two channels, having an output side at which at least one electric device (2) can be connected, a safety unit (3) with at least one connector (5) is provided for a power supply as well at least two outlets (6, 7), each connected to one channel (A, B) of the emergency-off switch (4), the safety unit (3) at the at least two outlets (6, 7) is provided with connected switches (8, 9), each of which connects to the power supply and is alternately switched on and off, and a measuring device (10) is provided for monitoring the power supply pulses at the outlets (6, 7) of the safety unit (3) and/or the outlets of the emergency-off switch (4), and/or at least one electric device (2) connected to the emergency-off switch (4).

2. An electric control according to claim 1, wherein the power supply is disconnected alternating and temporarily in an offset manner via the switches (8, 9).

3. An electric control according to claim 1, wherein the alternating disconnection of the power supply by the switches (8, 9) of the safety unit (3) is shorter than a reaction period of the downstream connected devices, and/or the emergency-off switches (4) and disconnection pulses last approximately 1 ms.

4. An electric control according to claim 3, wherein the measuring device (13) is embodied for monitoring the disconnection pulses and thus at least for cross circuits and/or short circuits.

5. An electric control according to claim 4, wherein the measuring device (13) is integrated into the safety unit (3) and/or in an at least one of the connected electric devices (2).

6. An electric control according to claim 5, wherein the switches (8, 9) of the safety unit (3) are semiconductor switches.

7. An electric control according to claim 1, wherein the electric connectors between the safety unit (3) and the emergency-off switch (4) and the at least one electric device (2) connected thereto is combined to supply power in a common, particularly unprotected wiring.
